(19) United States
(12) Patent Application Publication
(10) Pub. No.: US 2018/0195789 A1
(43) Pub. Date: Jul. 12, 2018

(54) TRANSPORT REFRIGERATION UNIT

(71) Applicant: CARRIER CORPORATION, Jupiter, FL (US)

(72) Inventor: Michael Swab, Acworth, GA (US)

(21) Appl. No.: 15/742,372

(22) PCT Filed: Jul. 7, 2016
(86) PCT No.: PCT/US16/41254

§ 371 Date: Jan. 5, 2018

Related U.S. Application Data
(60) Provisional application No. 62/189,374, filed on Jul. 7, 2015.

(51) Int. Cl. F25D 21/12; B60H 1/32; F25B 47/02

(52) U.S. Cl. CPC F25D 21/12; B60H 1/3226; F25B 2327/001; F25B 47/02; B60H 1/3232

(57) ABSTRACT

A transport refrigeration unit (26) includes a dedicated combustion engine system (56), an evaporator (50), and a de-frost heat exchanger (78) constructed and arranged to flow engine coolant in a heated state for defrosting the evaporator (50) when the dedicated combustion engine system (56) is not running. A method of operation may include running a defrost cycle of the unit (26) utilizing the heated coolant whether or not an associated internal combustion engine (66) of the unit (26) is running.

### BACKGROUND

The present disclosure relates to transport refrigeration units and, more particularly, to evaporator defrosting and associated control logic.

Traditional refrigerated cargo trucks or refrigerated tractor trailers, such as those utilized to transport cargo via sea, rail, or road, is a truck, trailer or cargo container, generally defining a cargo compartment, and modified to include a refrigeration system located at one end of the truck, trailer, or cargo container. Refrigeration systems typically include a compressor, a condenser, an expansion valve, and an evaporator serially connected by refrigerant lines in a closed refrigerant circuit in accord with known refrigerant vapor compression cycles. A power unit, such as a combustion engine, drives the compressor of the refrigeration unit, and may be diesel powered, natural gas powered, or other type of engine. In many tractor trailer transport refrigeration systems, the compressor is driven by the engine shaft either through a belt drive or by a mechanical shaft-to-shaft link. In other systems, the engine drives a generator that generates electrical power, which in-turn drives the compressor.

Evaporators of the refrigeration units are used during the refrigeration process to maintain appropriate temperatures within the cargo compartment. During the cooling cycle, humidity in the air within the cargo compartment may collect on the evaporator in the form of ice. Continued buildup of ice reduces the evaporator efficiency, thus a defrost cycle may be initiated by the unit to remove the ice. Manufacturers and operators of fleets of refrigerated trucks, trailers and/or cargo containers desire to maximize operational efficiency of the entire operation cycle(s) of the refrigeration system. One area of improvement may be made with respect to the defrosting capability of the refrigeration system.

### SUMMARY

A transport refrigeration unit according to one, non-limiting, embodiment of the present disclosure includes a dedicated combustion engine system constructed and arranged to dissipate residual heat when shut-down; an evaporator; and a defrost heat exchanger constructed and arranged to flow engine coolant in a heated state for defrosting the evaporator when the dedicated combustion engine system is shut-down.

Additionally to the foregoing embodiment, the transport refrigeration unit includes a supply conduit for flowing the engine coolant in the heated state from the combustion engine to the defrost heat exchanger, and a return conduit for flowing the engine coolant in a cooled state from the defrost heat exchanger to the combustion engine system.

In the alternative or additionally thereto, in the foregoing embodiment, the unit includes a pump constructed and arranged to flow the engine coolant in the supply and return conduits.

In the alternative or additionally thereto, in the foregoing embodiment, the unit includes a first valve constructed and arranged to control flow in the supply and return conduits.

In the alternative or additionally thereto, in the foregoing embodiment, the unit includes a pump disposed in the supply conduit for flowing the engine coolant to the defrost heat exchanger; and an isolation valve disposed in the return conduit.

In the alternative or additionally thereto, in the foregoing embodiment, the unit includes an engine heat exchanger for cooling the engine coolant; and a second valve for controlling flow through the engine heat exchanger.

In the alternative or additionally thereto, in the foregoing embodiment, the unit includes an evaporator fan constructed and arranged to flow air through the defrost heat exchanger and the evaporator, and wherein the defrost heat exchanger is disposed below the evaporator.

In the alternative or additionally thereto, in the foregoing embodiment, the pump is an electric pump.

In the alternative or additionally thereto, in the foregoing embodiment, the unit includes an air pressure differential transducer configured to measure ice buildup on the evaporator.

In the alternative or additionally thereto, in the foregoing embodiment, the unit includes an electronic controller in electrical communication with the air pressure differential transducer, and wherein the controller is configured to initiate a plurality of cooling cycles, determine a build-up of ice on the evaporator after each cooling cycle via at least the air pressure differential transducer, and initiate a defrost cycle accordingly regardless of whether the dedicated combustion engine system is running.

In the alternative or additionally thereto, in the foregoing embodiment, the evaporator, the defrost heat exchanger and the evaporator fan are in a cargo compartment.

In the alternative or additionally thereto, in the foregoing embodiment, the internal combustion engine system includes an internal combustion engine, a heat exchanger and an engine pump for flowing the engine coolant through the engine heat exchanger at least when the transport refrigeration unit is not in a defrost cycle.

In the alternative or additionally thereto, in the foregoing embodiment, the unit includes a defrost pump for flowing engine coolant through the defrost heat exchanger at least when the internal combustion engine is not running.

A method of operating a transport refrigeration unit according to another, non-limiting, embodiment includes initializing a defrost cycle when a combustion engine of the unit is not running; conducting residual heat from the combustion engine and to engine coolant; and flowing engine coolant in a heated state through a defrost heat exchanger.

Additionally to the foregoing embodiment, the method includes running a cooling cycle; and running the combustion engine during at least the cooling cycle, and heating the engine coolant via conduction from the running combustion engine.

In the alternative or additionally thereto, in the foregoing embodiment, the method includes determining coolant temperature is below a pre-programmed set point by a controller during the defrost cycle; and starting engine during the defrost cycle.

In the alternative or additionally thereto, in the foregoing embodiment, the method includes comparing an air pressure differential measured across the evaporator and a temperature of the evaporator to a pre-programmed bit map by a controller to determine whether defrost cycle should be initialized.

In the alternative or additionally thereto, in the foregoing embodiment, the method includes opening a valve to flow coolant through the defrost heat exchanger.

In the alternative or additionally thereto, in the foregoing embodiment, the method includes initializing an electric pump to flow coolant through the defrost heat exchanger and through the valve.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a side view of a tractor trailer system having a transport refrigeration unit as one, non-limiting, exemplary embodiment of the present disclosure;

FIG. 2 is a schematic of the transport refrigeration unit;

FIG. 3 is a schematic of the transport refrigeration unit; and

FIG. 4 is a flow chart of a method of operation of the transport refrigeration unit.

### DETAILED DESCRIPTION

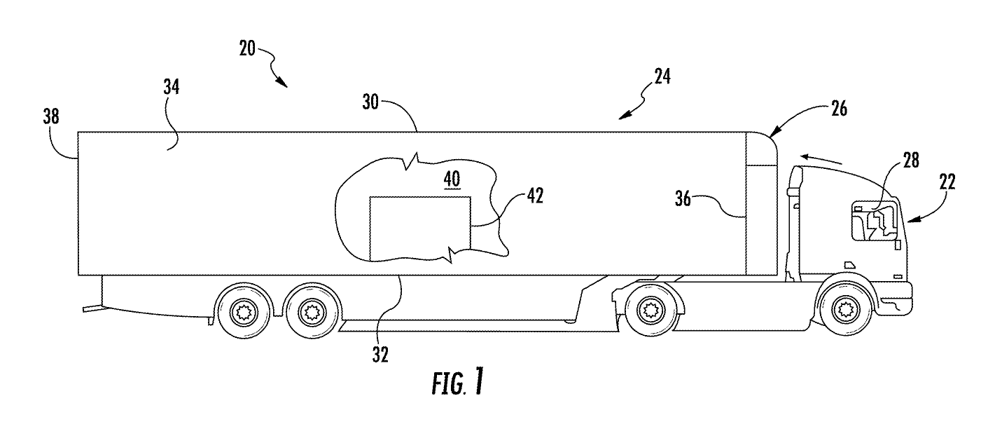

Referring to FIG. 1, one, non-limiting, embodiment of a tractor trailer system 20 of the present disclosure is illustrated. The tractor trailer system 20 may include a tractor 22, a trailer 24 and a transport refrigeration unit 26. The tractor 22 may include an operator's compartment or cab 28 and an engine (not shown) which is part of the powertrain or drive system of the tractor 22. The trailer 24 may be coupled to the tractor 22 and is thus pulled or propelled to desired destinations. The trailer may include a top wall 30, a bottom wall 32 opposed to and space from the top wall 30, two side walls 34 space from and opposed to one-another, and opposing front and rear walls 36, 38 with the front wall 36 being closest to the tractor 22. The trailer 24 may further include doors (not shown) at the rear wall 38, or any other wall. The walls 30, 32, 34, 36, 38 together define the boundaries of a cargo compartment 40.

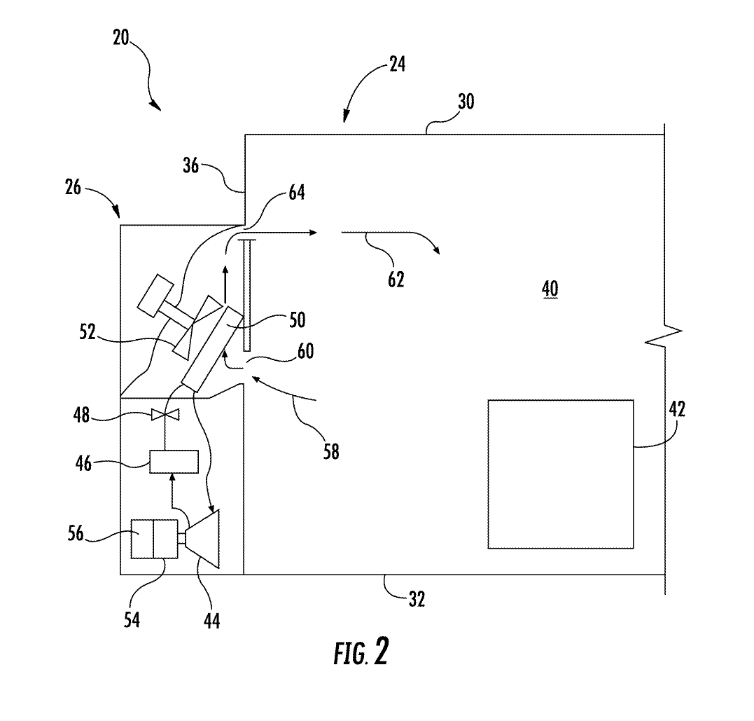

Referring to FIGS. 1 and 2, the trailer 24 is generally constructed to store a cargo 42 in the compartment 40. The refrigeration unit 26 is generally integrated into the trailer 24 and may be near the front wall 36. The cargo 42 is maintained at a desired temperature by cooling of the compartment 40 via the refrigeration unit 26 that circulates airflow into and through the cargo compartment 40 of the trailer 24. The refrigeration unit 26 may include a compressor 44, a condenser 46, an expansion valve 48, an evaporator 50, and an evaporator fan 52. The compressor 44 may be powered by an electrical generator 54 driven by an engine system 56.

During a cooling cycle of the refrigeration unit 26, a return airflow 58 flows into the refrigeration unit 26 from the cargo compartment 40 of the trailer 24 through a refrigeration unit inlet 60, and across the evaporator 50 via the evaporator fan 52, thus cooling the return airflow 58. Once cooled, the return airflow 58 becomes supply airflow 62 and is supplied to the cargo compartment 40 through an outlet 64 of the unit 26. The outlet 64 may be located near the top wall 30 and is generally spaced above the inlet 60.

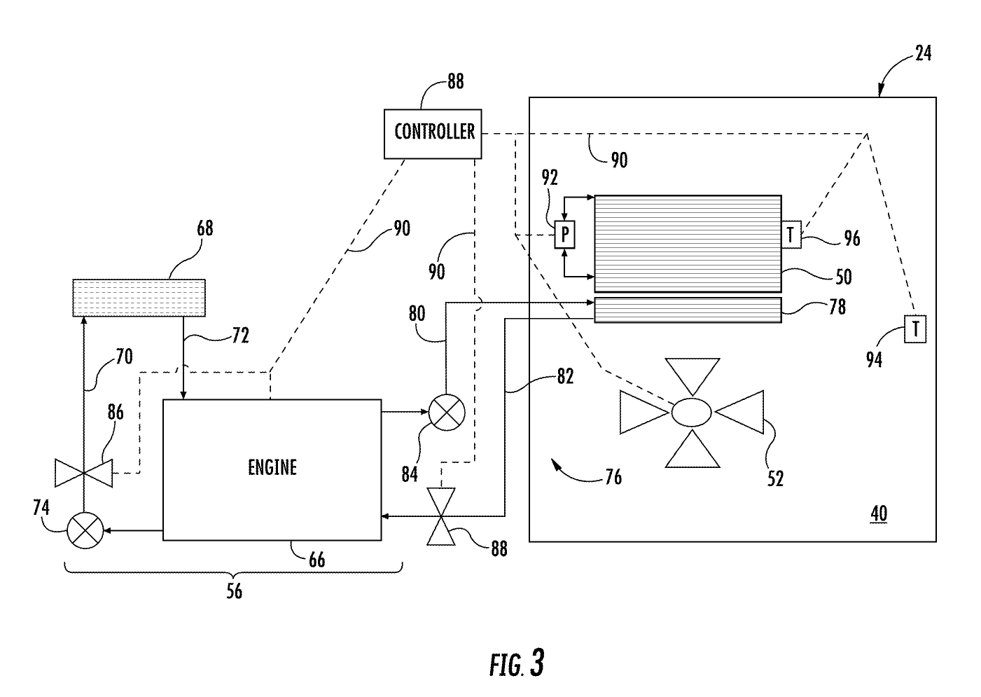

Referring to FIG. 3, the engine system 56 may include an internal combustion engine 66, an engine coolant heat exchanger 68, coolant supply and return conduits 70, 72, and an engine driven coolant pump 74 that may be generally located in the supply conduit 70. During operation, engine coolant in a heated state flows from the engine 66, through the supply conduit 70 (via the pump 74), through the heat exchanger 68 where the coolant is cooled into a cooled state, and back to the engine 66 via the return conduit 72.

The refrigeration unit 26 includes a defrost system 76 that is capable of defrosting the evaporator 50 whether the combustion engine 66 is running or not. When the combustion engine 66 is not running, the defrost system 76 utilizing the residual heat in the coolant and any residual heat produced by the cooling engine block to defrost the evaporator 50. The defrost system 76 may include a defrost heat exchanger 78 generally positioned between the evaporator fan 52 and the evaporator 50, supply and return conduits 80, 82 for flowing diverted engine coolant, a coolant pump 84 that may be electric, a first isolation valve 86 in the supply conduit 70 of the engine system 56 (i.e., downstream of the pump 74), and a second isolation valve 88 in the return conduit 82 of the evaporator system 76. It is further contemplated and understood that coolant tubes (not shown) of the defrost heat exchanger 78 may be interlaced in the evaporator 50.

When the transport configuration unit 26 calls for a defrost cycle, and with the internal combustion engine 66 running, the defrost system 76 is configured to reposition the isolation valve 86 from about an open position to a closed position, reposition the isolation valve 88 from a closed position to an open position, and initiate operation of the electric pump 84. Engine coolant in the hot state may then flow through the supply conduit 80, through the defrost heat exchanger 78, and back to the engine 66 via the return conduit 82 in the cooled state. If the refrigeration system 26 calls for shutdown of engine 66 during the defrost cycle, residual heat from the engine and in the coolant may still flow via the electric pump 84 and through the defrost heat exchanger 78 to continue the defrost cycle. Similarly, the defrost cycle may initiate without the engine running, and use any residual heat from a past run time of the engine 66 to defrost the evaporator 50. The system 76 may be further configured to initiate operation of the engine 66 (e.g., idle) if the defrost cycle is not yet complete and any residual heat in the coolant becomes ineffective, and/or temperature within the cargo compartment 40 requires an increase in temperature.

The defrost system 76 of the transport refrigeration unit 26 may further include an electronic controller 88, various wired and/or wireless signal paths 90, a differential pressure transducer 92 and two temperature sensors 94, 96. In operation, the controller may initiate electric signals to the various components to initiate the defrost system operation described above. More specifically, the controller 88 may utilize an electric signal from the differential pressure transducer 92 that measures an air pressure differential across the evaporator 50 with the evaporator fan 52 running. This pressure differential is an indicator of the buildup of ice on the evaporator (i.e., the higher the pressure differential the greater is the ice buildup). Such pressure differential measurements may be processed by the controller 88 toward a predicted end of a defrost cycle. When taken, the controller 88 may automatically determine when the defrost cycle should be prolonged or terminated if complete. The controller 88 may further utilize temperature signals from the temperature sensor 94 configured to measure cargo compartment air temperature, and temperature signals from the temperatures sensor 96 configured to measure the temperature of air flowing through the evaporator. The sensed temperature and differential values stored by the controller 88 may be compared to a pre-programmed bit map of calibrated values to ascertain the amount of ice buildup on the evaporator 50.

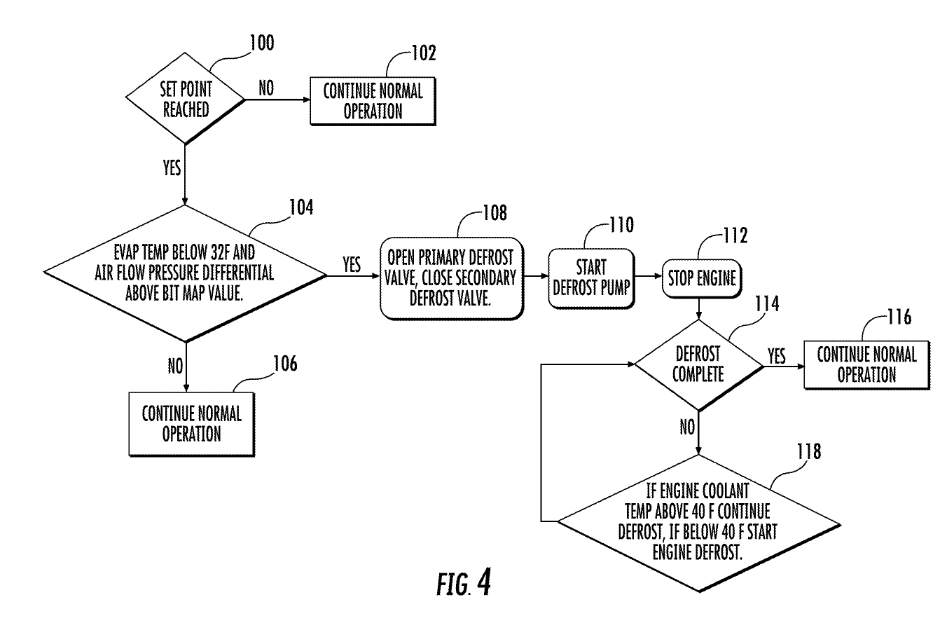

Referring to FIG. 4, one non-limiting example of a control logic of the defrost system 76 is illustrated. Within this logic, the controller 88 as step 100 establishes whether or not a set point is reached. This set point may be a temperature value of the cargo compartment 40 sensed by the temperature sensor 94. As a condition 102 and if the set point is not reached, the refrigeration unit 26 may continue normal operation (i.e., cooling the compartment) if the set point is reached, the controller moves to step 104. Step 104 is a determination by the controller 88 of whether an evaporator temperature has fallen below a preset value (e.g. about thirty-two degrees Fahrenheit (0° C.)) as measured by temperature sensor 96 and whether an air flow pressure differential across the evaporator is above a pre-established bit map value. As condition 106 and if no to either value, the unit 26 continues normal operation. As step 108 and if yes to both values/conditions set forth in step 104, then the controller 88 may open valve 88 and close valve 86. As step 110, the controller 88 may then start pump 84; and, as step 112, the controller may stop engine 66. With the engine 66 not running and the unit 26 is in the defrost cycle, the controller 88 as step 114 may then determine if the defrost cycle is completed utilizing a similar sequence of events described above. As a condition 116 and if the defrost cycle is complete, the refrigeration unit 26 reconfigures itself and continues with the normal cooling cycle. As step 118 and if the defrost cycle is not complete and the coolant temperature is above a set point (e.g., above forty degrees Fahrenheit (4.4° C.)) then the defrost cycle continues as configured. If the coolant temperature is below a prescribed set point, then the controller 88 may start the engine 66 to add heat to the process.

The defrost system 76 when compared to more traditional systems, enables less engine run time for defrost and less unnecessary/excessive defrost heat introduced into the cargo compartment 40. The improved ice removal from the evaporator 50 improves the cooling efficiency of the transport refrigeration unit 26.

It is further contemplated and understood that numerous other valve and pump configurations may be established to utilize residual heat from the engine 66 as part of a defrost process. For example, if engine pump 74 is an electric pump, pump 84 may not be required with the proper valving arrangement. Moreover, with a single pump, valves 86, 88 may be replaced with a single diverter valve. It is also contemplated that one or both valves may be control valves and coolant flow may be split between heat exchangers 68, 78 as required by the unit 26.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

1. A transport refrigeration unit comprising:
a dedicated combustion engine system constructed and arranged to dissipate residual heat when shut-down;
an evaporator; and
a defrost heat exchanger constructed and arranged to flow engine coolant in a heated state for defrosting the evaporator when the dedicated combustion engine system is shut-down.

2. The transport refrigeration unit set forth in claim 1 further comprising:
a supply conduit for flowing the engine coolant in the heated state from the combustion engine to the defrost heat exchanger, and a return conduit for flowing the engine coolant in a cooled state from the defrost heat exchanger to the combustion engine system.

3. The transport refrigeration unit set forth in claim 2 further comprising:
a pump constructed and arranged to flow the engine coolant in the supply and return conduits, and wherein the pump is independent of the dedicated combustion engine.

4. The transport refrigeration unit set forth in claim 2 further comprising:
a first valve constructed and arranged to control flow in the supply and return conduits.

5. The transport refrigeration unit set forth in claim 2 further comprising:
a pump disposed in the supply conduit for flowing the engine coolant to the defrost heat exchanger; and
an isolation valve disposed in the return conduit.

6. The transport refrigeration unit set forth in claim 4 further comprising:
an engine heat exchanger for cooling the engine coolant; and
a second valve for controlling flow through the engine heat exchanger.

7. The transport refrigeration unit set forth in claim 1 further comprising:
an evaporator fan constructed and arranged to flow air through the defrost heat exchanger and the evaporator, and wherein the defrost heat exchanger is disposed below the evaporator.

8. The transport refrigeration unit set forth in claim 5, wherein the pump is an electric pump.

9. The transport refrigeration unit set forth in claim 7 further comprising:
an air pressure differential transducer configured to measure ice buildup on the evaporator.

10. The transport refrigeration unit set forth in claim 9 further comprising:
an electronic controller in electrical communication with the air pressure differential transducer, and wherein the controller is configured to initiate a plurality of cooling cycles, determine a build-up of ice on the evaporator after each cooling cycle via at least the air pressure differential transducer, and initiate a defrost cycle accordingly regardless of whether the dedicated combustion engine system is running.

11. The transport refrigeration unit set forth in claim 7, wherein the evaporator, the defrost heat exchanger and the evaporator fan are in a cargo compartment.

12. The transport refrigeration unit set forth in claim 1, wherein the dedicated combustion engine system includes an internal combustion engine, a heat exchanger and an engine pump for flowing the engine coolant through the engine heat exchanger at least when the transport refrigeration unit is not in a defrost cycle.

13. The transport refrigeration unit set forth in claim 12 further comprising:
a defrost pump for flowing engine coolant through the defrost heat exchanger at least when the internal combustion engine is not running.

14. A method of operating a transport refrigeration unit comprising:
initializing a defrost cycle when a combustion engine of the unit is not running;
conducting residual heat from the combustion engine and to engine coolant; and
flowing engine coolant in a heated state through a defrost heat exchanger.

15. The method set forth in claim 14 further comprising:
running a cooling cycle;
running the combustion engine of the transport refrigeration unit during at least the cooling cycle;
heating the engine coolant via conduction from the running combustion engine.

16. The method set forth in claim 14 further comprising:
determining coolant temperature is below a pre-programmed set point by a controller during the defrost cycle; and
starting engine during the defrost cycle.

17. The method set forth in claim 14 further comprising:
comparing an air pressure differential measured across the evaporator and a temperature of the evaporator to a pre-programmed bit map by a controller to determine whether defrost cycle should be initialized.

18. The method set forth in claim 17 further comprising:
opening a valve to flow coolant through the defrost heat exchanger.

19. The method set forth in claim 18 further comprising:
initializing an electric pump to flow coolant through the defrost heat exchanger and through the valve.
